(19) United States
(12) Patent Application Publication
(10) Pub. No.: US 2026/0326630 A1
(43) Pub. Date: Oct. 22, 2026

(54) COMBINED ROTATIONAL AND TRANSLATIONAL MOVEMENT-LIMITING DEVICE

(71) Applicant: ISRINGHAUSEN GmbH & Co. KG, Lemgo (DE)

(72) Inventors: Jörg BREDEMEIER, Auetal (DE); Daniel MILINSKI, Blomberg (DE)

(73) Assignee: ISRINGHAUSEN GmbH & Co. KG, Lemgo (DE)

(21) Appl. No.: 19/646,829

(22) Filed: Apr. 14, 2026

(30) Foreign Application Priority Data
Apr. 16, 2025 (DE) 10 2025 114 905.4

(51) Int. Cl. B60N 2/07; B60N 2/02; B60N 2/14

(52) U.S. Cl. CPC B60N 2/0727; B60N 2/14; B60N 2002/022

(57) ABSTRACT

A device for limiting a rotational and translational movement for a seat base, wherein the seat base includes an upper part and a lower part. The upper part and the lower part are rotationally and/or translationally movable relative to one another by an adjusting unit including at least one flexible limiting element with an upper end and with a lower end. The upper end is fixed to the upper part at an upper connection point, and the lower end is fixed to the lower part at a lower connection point. The at least one flexible limiting element limits the translational and/or rotational movement of the upper part and of the lower part relative to one another.

### FIELD OF INVENTION

The present invention relates to a device for limiting a rotational and/or translational movement. The invention also relates to a seat for a vehicle which has a device for limiting a rotational and/or translational movement. The invention also relates to the use of a flexible limiting element for limiting a rotational and/or translational movement.

### BACKGROUND OF RELATED ART

Seats, particularly in vehicles such as utility vehicles, must meet the user's requirements in terms of ergonomic comfort and handling while also being adapted to the basic conditions prescribed by the vehicle. This can lead to a conflict between the desired freedom of movement and the limited space available, particularly in a vehicle such as a utility vehicle. On the one hand, collisions with other parts, for example in a vehicle, particularly in a utility vehicle, need to be avoided. On the other hand, the operation of a seat, particularly in a vehicle such as a utility vehicle, should be unrestricted and as efficient as possible. For this purpose, it may be necessary to limit an existing degree of freedom of a seat at certain positions and in certain orientations, particularly in a vehicle, for example a utility vehicle, and to enable it at other positions or orientations.

For example, gates and stops are known for limiting a movement. In particular, it is known to set an angle of rotation for a seat so that it does not collide with other parts in the vehicle regardless of its position in the vehicle. The problem with such swivel seats is that the user's freedom of movement is restricted, which results in reduced ergonomic comfort during extended periods of use.

DE 10 2023 113 094 A1 relates to a vehicle seat in which a dependency between displacement and angle of rotation can be established by a first stop element and a second stop element.

DE 10 2015 212 459 A1 discloses a seat for a construction machine and a construction machine. The stop limiting device described therein creates a variable stop that is dependent on the current angle of rotation of the seat and the set position of the lateral displacement of the seat and thus provides different stops for different seat positions. The stop limiting device can have a stop gate and a stop device that interacts with the stop gate.

### SUMMARY

The known solutions from the prior art either unnecessarily restrict the degree of freedom of a vehicle seat or are complex to manufacture, operate, and/or install.

It is the object of the present invention to extend the setting options for limiting a rotational and/or translational movement and to implement the solution to the aforementioned problems in an especially simple and efficient manner.

According to the invention, this object is achieved by a device for limiting a rotational and/or translational movement with the features of claim 1. The object is also achieved by a seat for a vehicle which has a device for limiting a rotational and/or translational movement with the features according to claim 6. The object is also achieved by the use of a flexible limiting element according to claim 7. Advantageous embodiments are specified in the subclaims.

Accordingly, the object is achieved by a device for limiting a rotational and translational movement for a seat base, the seat base comprising an upper part and a lower part, the upper part and the lower part being rotationally and/or translationally movable relative to one another by means of an adjusting unit; comprising at least one flexible limiting element with an upper end and with a lower end; the upper end being fixed to the upper part at an upper connection point; the lower end being fixed to the lower part at a lower connection point; and the at least one flexible limiting element limiting the translational and/or rotational movement of the upper part and of the lower part relative to one another.

A device for limiting a rotational and translational movement for a seat base limits the degrees of freedom of the individual elements of the seat base in relation to one another. On the one hand, a rotational movement of the individual elements is limited and, on the other hand, a translational movement of the individual elements is limited.

A seat base refers in particular to the connection between the seat assembly and the floor of a vehicle. The seat base preferably consists of a lower part of the seat base, which can be firmly connected to the floor of a vehicle, and an upper part of the seat base to which a seat assembly can be attached directly or indirectly. An adjusting unit that allows translational and/or rotational movement can be provided between the upper part and the lower part of the seat base. A rotation element and/or a translation element are preferably provided for this purpose.

Translational movement refers to movement along an axis, preferably along the longitudinal and/or transverse axis of the vehicle. More preferably, a translational movement is a movement along the longitudinal axis of the vehicle.

A rotational movement is a rotation around an axis. The axis can be fixed. Preferably, the axis of rotation is the vertical axis of the upper part of the seat base, in particular the vertical axis of a seat.

A translation element enables the described translational movement. The translation element can be designed in such a way that it guides the translational movement. Preferably, the translation element has a locking function that enables the upper part and the lower part of the seat base to be fixed in a relative position to one another. It is more preferably a rail guide.

The rotation element enables the described rotational movement. The rotation element can be configured to rotate the upper part of the seat base.

The upper part of the seat base and/or the lower part of the seat base can be moved rotationally and/or translationally relative to one another, which is made possible in particular by means of an adjusting unit. A relative movement can be achieved by a rotational and/or translational movement of the lower and/or upper part of the seat base independently of one another. Preferably, a relative movement can be achieved by a rotational and/or translational movement of the upper part of the seat base with respect to a lower part of the seat base that is stationary.

According to the invention, the relative translational and/or rotational movement of the upper part and of the lower part of the seat base with respect to one another is limited by at least one flexible limiting element.

The at least one flexible limiting element can be loaded with tensile resilience, the flexible limiting element being preferably tensioned when loaded; the flexible limiting element, when loaded with tensile resilience, can transfer the forces that occur, preferably directly or indirectly, to the seat base. In particular, the flexible limiting element reaches a predetermined length when tensioned. Preferably, the flexible limiting element can be an elastic element with a finite extension to a predetermined length.

The at least one flexible limiting element preferably has an upper and a lower end. An upper and a lower end preferably dimension the at least one flexible limiting element, the section between an upper and a lower end corresponding to the length of a flexible limiting element.

In particular, an upper and a lower end can also be a beginning and an end of a flexible limiting element. Preferably, the designation of an upper and a lower end describes the reference to the element of the seat base to which the respective end is fixed. More preferably, the upper end can be attached to an upper connection point on the upper part of the seat base and/or the lower end can be attached to a lower connection point on the lower part of the seat base.

A connection point preferably designates a position on the upper part and/or lower part of the seat base; a receptacle for connecting a connection element to an upper part and/or lower part of the seat base is more preferably located at a connection point, a receptacle preferably having at least one thread.

One end of a flexible limiting element is fixed in particular by connecting it directly or indirectly to the corresponding element of the seat base, this connection being preferably detachable. In particular, the connection of one end of a flexible limiting element can be made via a connecting element, the connecting element being preferably positioned between one end of a flexible limiting element and an upper part and/or lower part of the seat base.

A connecting element can be preferably connected to one end of a flexible limiting element and/or to an upper part and/or lower part of the seat base, the connection to a part of the seat base preferably occurring at a connection point. In particular, an upper end of a flexible limiting element can be connected to the upper part of the seat base via an upper connecting element and/or a lower end of a flexible limiting element can be connected to the lower part of the seat base via a lower connecting element. Preferably, the connection of a connecting element to a part of the seat base and/or to one end of a flexible limiting element is detachable. In particular, the designation of an upper and a lower connecting element describes the relationship to the part of the seat base to which the respective connecting element is attached.

A connecting element can be designed in one or more parts and preferably has connection points for connection to one end of a flexible limiting element and/or for connection to a part of the seat base. Preferably, a connecting element enables a flexible limiting element to be aligned, especially when it is loaded with tensile resilience. A connecting element can, for example, comprise a plate, an angular element, a clevis, an eyelet, and/or a swivel or a combination thereof. In particular, a connecting element can be made of metal, plastic, and/or a composite material or a combination thereof.

According to the invention, the at least one flexible limiting element limits the translational and/or rotational movement of the upper part of the seat base and of the lower part of the seat base relative to one another, the movement being preferably limited in such a way that only a predetermined maximum angle of rotation and/or a predetermined maximum translational movement can be achieved. The maximum permissible rotational and/or translational movement can be preferably specified via the positioning of the attachment points on the upper part and/or lower part of the seat base; the upper attachment point is preferably positioned below the upper part of the seat base and at the rear in the seating direction; the lower attachment point is preferably positioned on the lower part of the seat base at the front in the seating direction; the rotational movement to the right and/or the translational movement is limited by the positioning of the attachment points in the seating direction to the right of the vertical axis of the upper part and/or lower part of the seat base; the rotational movement to the left and/or the translational movement is preferably limited by the positioning of the attachment points in the seating direction to the left of the vertical axis of the upper part and/or lower part of the seat base.

Preferably, the limiting of the rotational movement of the upper part and of the lower part of the seat base relative to one another can be carried out by a flexible limiting element and/or the limiting of the translational movement of the upper part and of the lower part of the seat base relative to one another can be carried out by at least one further flexible limiting element.

More preferably, the limiting of the rotational and/or translational movement of the upper part and of the lower part of the seat base relative to one another can be achieved by a single flexible limiting element.

In particular, the rotational movement of the upper part and of the lower part of the seat base in relation to one another can be limited only in a fixed direction of rotation to the right or to the left in the seating direction, while the respective other direction of rotation is not limited.

In particular, the rotational movement of the upper part and of the lower part of the seat base in relation to one another can be limited in both directions in the seating direction to the left and to the right. Preferably, this can be achieved by two devices for limiting the translational and/or rotational movement, with a first device limiting the rotational movement to one side and a second device limiting the rotational movement to another side; in particular, both devices can limit the translational movement. Preferably, the translational movement can be limited by only one of the two devices.

The invention makes it especially simple to limit a possible angle of rotation between an upper part of a seat base and a lower part of a seat base as a function of a translational displacement between the two parts. In addition, the translational displacement between the parts of the seat base is limited by a single flexible limiting element as a function of the angle of rotation between the parts. This makes it possible to limit the rotatability of a seat in areas of a vehicle with less space without also having to unnecessarily limit the rotatability in areas of a vehicle with more space. It is also possible to adapt the limitation of movement individually and particularly easily to the available space by positioning the connection points.

It can be advantageous to limit the translational and/or rotational movement in a variably adjustable manner via a relative position of the upper connection point and of the lower connection point to one another and/or via a length of the flexible limiting element.

Preferably, the limitation of the translational and/or rotational movement can depend on the relative position of the connection points to one another, the relative position describing in particular the distance of the connection points from one another. More preferably, the relative position of the attachment points to one another can change as a result of a translational and/or rotational movement of the upper part and/or of the lower part of the seat base; the restriction of translational and/or rotational movement by the device according to the invention preferably increases the farther the positions of the attachment points are separated from one another.

In particular, the limitation of the translational and/or rotational movement can be variably adjusted by increasing or decreasing the distance between the connection points, the adjustment being preferably made by changing the position of the upper part and/or of the lower part of the seat base relative to one another.

Especially advantageously, the lower part of the seat base and thus a lower connection point is stationary; the lower connection point serves as a stationary reference for the upper connection point; the position of the upper connection point relative to the lower connection point is preferably changed by a translational and/or rotational movement of the upper part of the seat base; the change in the position of the upper connection point relative to the lower connection point sets the limit of the maximum permissible translational and/or rotational movement of the upper part of the seat base.

More preferably, the limitation of movement is achieved via the fixed length of a flexible limiting element; the length of the flexible limiting element preferably determines the maximum distance of the connection points from one another, the length being in particular between 50 mm and 600 mm, more preferably between 100 mm and 500 mm.

This is especially advantageous, as the invention simplifies operation, increases the user's freedom of movement, and improves ergonomic comfort. The device is also especially simple to adapt to the dimensions of a seat base and the available space, particularly in a vehicle, for example a utility vehicle.

It can be advantageous if a flexible limiting element of the device for limiting the translational and/or rotational movement is a belt. Preferably, the belt can be a seat belt strap.

A belt refers to an element which, in particular, fulfills the described properties of the flexible limiting element, can be loaded with tensile resilience; the belt can, in particular, be a woven belt, a strap, or a seat belt strap.

In particular, the belt can have a low elastic deformation, and the maximum value of the static elongation at 10 kN can lie in a range between 6% and 20%, more preferably between 11% and 15%.

In particular, the belt can be made of a tear-resistant material such as nylon or polyester.

In particular, the belt can be made of a flame-retardant material.

Preferably, a flexible limiting element can, for example, be a chain element with chain links or an elastic element with a fixed maximum deflection, in particular a spring element with a fixed maximum deflection.

This is especially advantageous, as it is a simple, maintenance-free element that is already available in various designs and can be easily adapted in length.

It can be advantageous if the flexible limiting element of the device according to the invention can be rolled up, in particular by means of an automatic retractor.

An automatic retractor can preferably partially or completely take up the flexible limiting element; the automatic retractor preferably rolls up the flexible limiting element when it is not tensioned and is thus relieved; the automatic retractor preferably releases the flexible limiting element when it is loaded with tensile resilience and is thus tensioned. In particular, an automatic retractor can have an elastic element, for example a spring element, which is suitable for retrieving an unwound flexible limiting element.

A flexible limiting element is preferably rolled up by winding it onto itself, particularly in such a way that the winding of the flexible limiting element can be easily reversed by unrolling. Preferably, winding takes place via a carrier element, the carrier element being preferably a rotationally symmetrical element, in particular a roller and/or a spindle.

Preferably, the automatic retractor can lock a release of the completely or partially rolled-up flexible limiting element by unrolling; by locking the release of a completely or partially rolled-up flexible limiting element, its length can be preferably changed, in particular shortened; the locking of the unrolling is preferably controllable. In particular, the locking of the unrolling of a flexible boundary element can be controlled during use, preferably by a user. Preferably, the locking mechanism can be controlled manually, in particular via a lever. Another preferred method of controlling the locking mechanism is via an electric control element.

Rolling up a flexible boundary element is especially advantageous, as this allows a flexible boundary element to be stowed away to save space when it is not under tension. Furthermore, the roll-up mechanism advantageously offers an additional functionality with which a length of a flexible limiting element can also be changed and adjusted during use, which enables additional individual adaptation to the user's needs.

It can also be advantageous if the position of the upper connection point and/or the position of the lower connection point is adjustable.

The positions of the upper and/or lower connection points can be preferably adjusted independently of one another; an adjustment preferably brings about a change in the positions, it being possible for the adjustment to be made in particular during use by a user. The position of an upper and/or lower connection point can be changed from an original initial position, preferably in the seating direction to the left and/or to the right, more preferably in the seating direction to the front and/or rear.

Preferably, by changing the attachment points of a flexible limiting element from an initial position in the seating direction on one side of the vertical axis to a position on the other side of the vertical axis, a reversal of the limiting direction of the limitation of rotational movement can be achieved; one side of the vertical axis can be preferably a left and/or right side of the upper part and/or lower part of the seat base in the seating direction. In particular, by changing the positions from an initial position to the right of the vertical axis to new positions to the left of the vertical axis, the limitation of a rotational movement to the right in the direction of rotation and seating direction can be reversed to a limitation to the left. More preferably, by changing the positions from an initial position to the left of the vertical axis to new positions to the right of the vertical axis, the limitation of a rotational movement to the left in the direction of rotation and seating direction can be reversed to a limitation to the right.

Preferably, the distance between the connection points can be changed by changing the positions of the connection points; shortening the distance between the connection points while maintaining the same length of the flexible limiting element increases the maximum permitted rotational and/or translational movement; increasing the distance between the connection points while maintaining the same length of the flexible limiting element reduces the maximum permitted rotational and/or translational movement.

The positions can be preferably set along a guide; the guide in particular enables a position to be changed along a predetermined axis, more preferably along a circular path; the guide can more preferably have a locking function, which in particular can fix a connection point at a new position. A connection point is fixed particularly in such a way that a force can be transmitted from a flexible limiting element to a connection point; the force transmission can be preferably form-fitting; a form-fitting element can be preferably embodied as a bolt in a recess; the bolt can be preferably engaged and disengaged. Preferably, the engagement and disengagement of a form-fitting element can be controlled, preferably by a mechanical mechanism, for example by a spring element; the control can be preferably carried out by a user, in particular via a lever mechanism. Preferably, the engagement and disengagement of a form-fitting element can be controlled electrically; the control can be preferably carried out by a user, in particular via a control element.

According to the invention, this makes it possible to adjust the limitation of the translational and/or rotational movement during use. This offers the advantage that a limitation of movement can be individually adapted to the respective user requirements.

The object of the invention is also achieved by a seat for a vehicle, in particular for a utility vehicle, which has a device according to the invention for limiting a rotational and translational movement.

The device for limiting a rotational and translational movement can be preferably already integrated into the seat for a vehicle; the maximum possible angle of rotation and/or the maximum translational movement that a seat can perform is preferably designed for the individual space available in the vehicle, particularly in a utility vehicle.

A seat for a vehicle, in particular for a utility vehicle, can have a seat base with an upper part and a lower part, these two parts being movable rotationally and/or translationally relative to one another. The rotational and/or translational movement can be made possible by an adjusting unit, which can be positioned between the upper part and the lower part of the seat base. The lower part of the seat base can be connected to the vehicle floor. A seat for a vehicle, in particular a utility vehicle, can also have a seat assembly which is suitable for enabling sitting, in particular ergonomic sitting, in a vehicle, in particular a utility vehicle, for a user. The seat assembly can preferably have a seat surface and a backrest. In particular, the seat assembly can have at least one armrest; the at least one armrest can be adjustable, it being preferably foldable up and/or down at a pivot point.

A utility vehicle can be a vehicle that is designed to transport people and/or goods and/or to pull loads and/or is used to perform work. A utility vehicle can be, in particular, a truck, a bus, an agricultural machine, and/or a construction machine.

A seat for a vehicle, in particular a utility vehicle, has a device for limiting rotational and translational movement. The seat therefore has the same advantages as a device for limiting a rotational and translational movement and can be refined in a corresponding manner; conversely, the advantages of the seat also apply respectively to the device for limiting a rotational and translational movement.

The object of the invention is also achieved through use of at least one flexible limiting element for limiting a rotational and/or translational movement of an upper part and a lower part relative to one another, the movement being limited by fixing an upper end of the flexible limiting element at an upper connection point on the upper part and a lower end of the flexible limiting element at a lower connection point on the lower part.

By using a preferably common flexible limiting element to limit the rotational and/or translational movement instead of, for example, two rigid stops, it is possible to couple the translational movement to the rotational movement and/or the rotational movement to the translational movement. In particular, this coupling can be achieved using a single flexible limiting element.

The object according to the invention can thus be achieved in an especially simple and efficient manner. In particular, an improvement in ergonomic comfort can be achieved using a small number of required components.

The use of at least one flexible limiting element is preferably designed to limit the described rotational and/or translational movement. The use therefore has the same advantages as the flexible limiting element and can be refined in a corresponding manner; conversely, the advantages of the use also apply respectively to the flexible limiting element.

### BRIEF DESCRIPTION OF THE DRAWINGS

Further details and advantages of the invention are explained in greater detail with reference to the exemplary embodiments shown in the drawings, in which:

FIGS. 1a-1c show an exemplary schematic representation of a device for limiting a rotational and/or translational movement, fixed to a seat base with an embodiment with connecting elements and a seat belt strap;

FIGS. 2a-2c show an integrated installation of an embodiment of a device for limiting a rotational and/or translational movement with connecting elements and a seat belt strap;

FIGS. 3a-3c show a retrofittable installation of an embodiment of a device for limiting a rotational and/or translational movement with connecting elements and a seat belt strap; and FIGS. 4a-4d show a schematic representation of exemplary positions of the upper and lower connection points.

### DETAILED DESCRIPTION

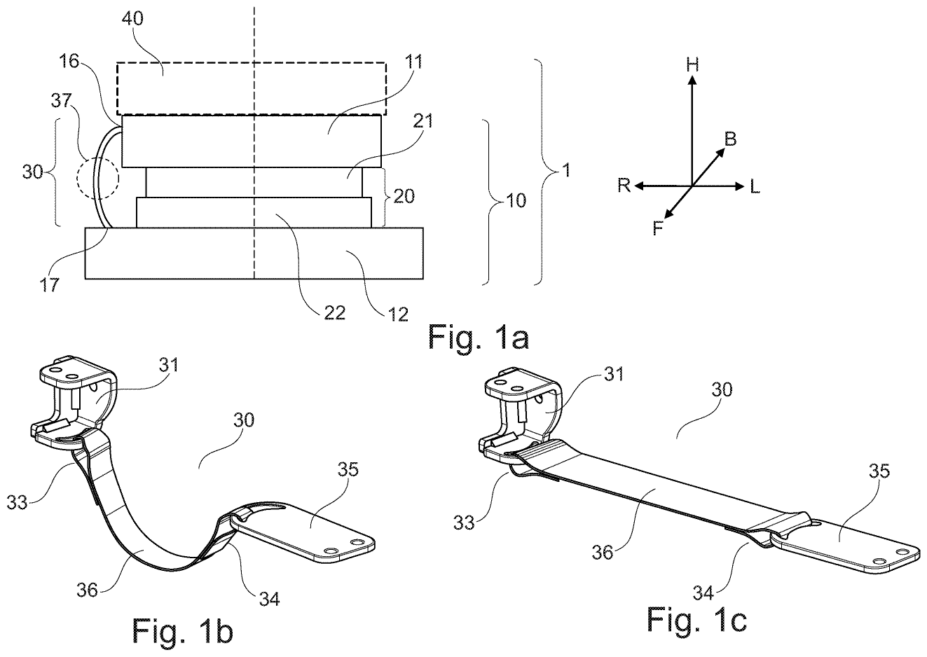

FIG. 1a shows a schematic representation of a device for limiting a rotational and/or translational movement 30 and fixing it to a seat base 10 of a seat 1. The seat base 10 comprises an upper part 11 and a lower part 12, as well as an adjusting unit 20. The adjusting unit 20 is also shown as consisting of a rotation element 21 and a translation element 22. The adjusting unit 20 is positioned between the upper part 11 and the lower part 12 of the seat base 10.

The device for limiting a rotational and/or translational movement 30 is attached to the upper part 11 of the seat base 10 at an upper attachment point 16 and to the lower part 12 of the seat base 10 at a lower attachment point 17. The seat assembly 40 can be attached to the upper part 11 of the seat base 10, as indicated by the dotted line in FIG. 1a.

The directions front and back as well as right and left refer to the seating direction and are illustrated in the coordinate system shown. The R-and L-axes indicate left and right; the direction B indicates the direction backward; and the direction F points forward. The H-axis is the vertical axis, which is also the axis of rotation. It is also shown by the dashed vertical line in FIG. 1a as the vertical axis of the upper part 11 of the seat base 10.

FIGS. 1b and 1c show a specific embodiment of the device for limiting a rotational and/or translational movement 30 from FIG. 1a. In this embodiment, the flexible limiting element is embodied as a seat belt strap 36. In the following, the specific flexible limiting element of the seat belt strap 36 from FIGS. 1b and 1c is used to describe the mode of operation of the construction shown in 1a. FIG. 1 b shows a seat belt strap 36 in a relieved state, as it sags. FIG. 1c shows the seat belt strap 36 in a fully tensioned state. The construction of the device for limiting a rotational and/or translational movement 30 is the same for FIGS. 1b and 1c and can therefore be described with reference to FIG. 1b.

An upper end 33 of the seat belt strap is connected to an upper connecting element 31, and a lower end 34 of the seat belt strap 36 is connected to a lower connecting element 35. The two ends are connected to the connecting elements 31 and 35 via a loop at the respective end of the seat belt strap 36. As a result, the upper end 33 is fixed indirectly via the upper connecting element 31 to the upper connecting point 16 on the upper part 11 of the seat base 10 shown in FIG. 1a. The same applies to the lower end 34 of the seat belt strap 36. This is fixed indirectly via the lower connecting element 35 to the lower connecting point 17 on the lower part 12 of the seat base 10 shown in FIG. 1a.

In the specific embodiment shown in FIGS. 1b and 1c, the seat belt strap 36 has a stretched length between the connecting elements 31 and 35 of 221 mm and a width of 38 mm. The loops at both ends of the seat belt strap also create an overlap of 58 mm at the upper 33 and lower 34 ends of the seat belt strap.

In the specific embodiment shown in FIGS. 1b and 1c, the seat belt strap 36 also has a tensile strength of over 10 kN.

The material of the seat belt strap 36 in the specific embodiment is also flame-retardant, designed for a temperature range of −40 °C to +85 °C and achieves a maximum static elongation of 12% at 10 kN.

The upper connecting element 31 is a metal angular element, and the lower connecting element 35 is a metal plate. An arc-shaped recess can be seen on both connecting elements to which the upper 33 and lower 34 ends of the seat belt strap 36 are connected. The lower connecting element 35 has two through holes. The upper connecting element has three through holes. The connecting elements can be attached to the upper part 11 and the lower part 12 of the seat base 10 via the through holes.

In addition, an automatic retractor 37 is indicated by a dashed circle in FIG. 1a, which in a specific embodiment is positioned between an upper 31 and a lower end 34 of the flexible limiting element.

The lower part 12 of the seat base is fixed in the exemplary embodiment in FIG. 1a and is therefore stationary. The translation element 22 of the adjusting unit 20 allows a translational movement of the upper part 11 of the seat base 10, so it can move forward and backward. Movement forward corresponds to movement out of the drawing plane, and movement backward corresponds to movement into the drawing plane. The rotation element 21 allows the upper part 11 of the seat base 10 to rotate so that it can turn about its own vertical axis, to the left and to the right.

With the translation and rotation of the upper part 11 of the seat base 10, a seat assembly 40 mounted on the upper part 11 also performs this movement. Due to the fixation of the lower part 12 of the seat base 10, the lower connection point 17 serves as a stationary reference for the upper connection point 16. The position of the upper connection point 16 relative to the lower connection point 17 changes with the translational and/or rotational movement of the upper part 11 of the seat base 10. When the upper connection point 16 with the upper connection element 31 moves away from the lower connection point 17 with the lower connection element 35, the intermediate seat belt strap 36 stretches.

In the exemplary embodiment shown in FIG. 1a, the device for limiting a rotational and/or translational movement is positioned on the right-hand side of the vertical axis in the seating direction. Therefore, the distance between the connection points 16 and 17 increases when the upper part 11 of the seat base rotates to the right in the seating direction. In addition, the distance between the connection points 16 and 17 also increases when the upper part 11 of the seat base 10 is moved backward. The distance between the connection points also increases when the described translational and rotational movement of the upper part 11 of the seat base 10 is superposed. The seat belt strap 36 becomes tauter the farther the upper connection point 16 with the upper connection element 31 moves away from the lower connection point 17 with the lower connection element 35, until the seat belt strap 36 is completely taut.

The automatic retractor 37 takes up all or part of the seat belt strap 36 when it is not tensioned. When the seat belt strap is tensioned, the automatic retractor 37 releases the seat belt strap again.

The adjusting unit 20 therefore enables rotational and/or translational movement of the upper part 11 of the seat base 10 relative to the lower part 12 of the seat base 10. As a result of a translational and/or rotational movement of the upper part 11 and/or of the lower part 12, the flexible limiting element 32, embodied here as a seat belt strap 36, is tensioned or relieved. When it is fully tensioned, the permitted translational and/or rotational movement is exhausted, and any movement beyond this is limited. The more the available range of movement is exhausted by rotating the upper part 11 of the seat base 10, the more the permitted translational movement is reduced. The same applies to the maximum permitted rotational movement if part of the range of movement has already been exhausted by a translational movement of the upper part 11 of the seat base 10.

During the translational and/or rotational movement of the upper part 11 of the seat base 10, the circular arc-shaped recesses of the upper 31 and lower 35 connecting element in particular serve to allow the seat belt strap 36 attached thereto to align itself. This is additionally promoted by the play that is present due to the loop connection at the upper 33 and lower end 34. The flat design of the lower connecting element 35 as a plate can be advantageously integrated into the seat base 10 in such a way that little installation space is required. The upper connecting element 31 also makes efficient use of the available installation space by virtue of the angled design and also enables unhindered alignment of the seat belt strap 36.

Accordingly, the flexible limiting element 32 couples the translational movement of the upper part 11 and of the lower part 12 of the seat base 10 to one another, to the rotational movement, and vice versa, the translational and rotational movements utilizing a common contingent of movement clearance.

The additional function of the automatic retractor 37 means that the seat belt strap 36 is rolled up and stowed away in the untensioned state instead of sagging.

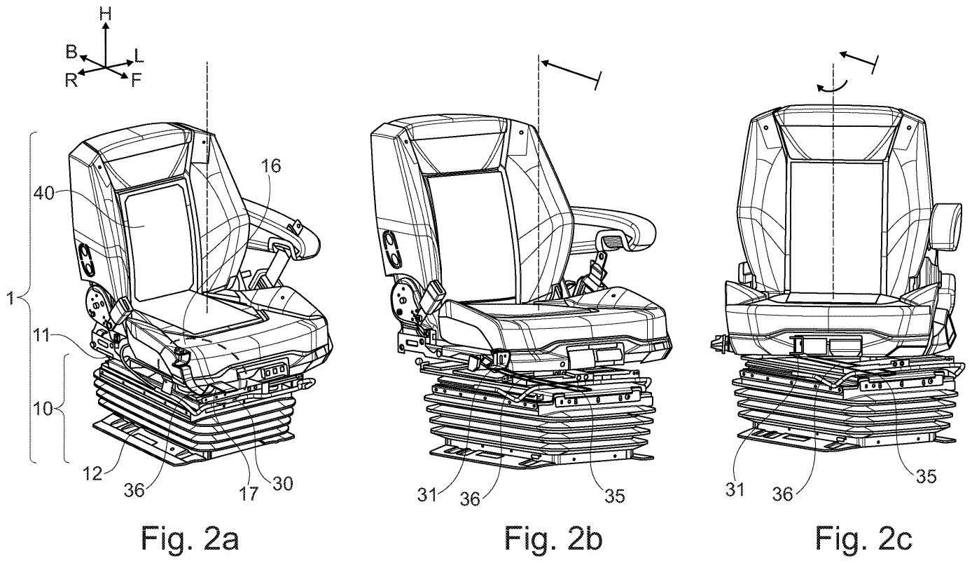

An integrated installation of an embodiment of a device for limiting a rotational and/or translational movement with connecting elements and a seat belt strap will be described with reference to FIGS. 2a to 2c. This is based on the exemplary embodiment shown above; in particular, the same reference symbols are used for elements with the same function as in FIGS. 1a to 1c.

FIG. 2a shows a device for limiting a rotational and/or translational movement 30 in an integrated installation position in a seat 1 with seat assembly 40. From left to right, different positions of the seat assembly 40 and thus of the upper part 11 of the seat base 10 are shown in FIGS. 2a to 2c, resulting in different relative positions of the connection points 16 and 17 and thus also of the connection elements 31 and 35 in relation to one another.

The rotational and/or translational movement that has led to the position shown is illustrated by the arrows above the figures. The coordinate system illustrates the orientations in the seating direction. The R-and L-axes indicate left and right; the direction B indicates the direction backward; and the direction F points forward. The H-axis is the vertical axis, which is also the axis of rotation. It is also shown by the dotted vertical line as the vertical axis of the upper part 11 of the seat base 10. The structure remains the same for all positions shown and can be described using FIG. 2a.

The device for limiting a rotational and/or translational movement 30 has an upper 31 and a lower 35 connecting element. The flexible limiting element is embodied as a seat belt strap 36. The upper connecting element 31 is fixed to the upper part 11 of the seat base 10 and connects it to the upper end of the seat belt strap 36. The lower connecting element 35 is fixed to the lower part 12 of the seat base 10 and connects it to the lower end of the seat belt strap 36.

The lower connection point 17 and thus the lower connection element 35 are positioned on the lower part 12 of the seat base 10 at the front in the seating direction and to the right of the vertical axis of the lower part 12. The upper connection point 16 and thus the upper connection element 31 are positioned below the upper part 11 of the seat base 10 in the rear seating direction and to the right of the vertical axis of the upper part 11.

The seat assembly 40 is attached to the upper part 11 of the seat base 10. In the exemplary embodiment in FIG. 2a, the lower part 12 of the seat base 10 is firmly connected to the vehicle floor and is therefore stationary. This means that the lower connecting element 35 is also fixed and serves as a reference for the maximum rotary movement of the upper part 11. The upper part 11 of the seat base 10, with the seat assembly 40 attached thereto, can be moved forward and backward in the seating direction and rotated about its vertical axis. The seat belt strap 36 is tensioned when the upper and lower connection points 16 and 17 and thus the upper and lower connection elements 31 and 35 are moved farther apart from one another. In the tensioned state, it is no longer possible to move the upper and lower connection points 16 and 17 and thus the upper and lower connection elements 31 and 35 farther apart from one another.

FIG. 2a shows an initial position of the upper part 11 of the seat base 10 with seat assembly 40 in which the upper part 11 is displaced translationally forward and in the seating direction as far as possible. The upper and lower connection points 16 and 17 and thus the upper and lower connection elements 31 and 35 are the shortest distance apart in this position, so the seat belt strap 36 sags. The maximum angle of rotation of the upper part 11 of the seat base 10 with seat assembly 40 is possible in this position.

FIG. 2b shows an orientation of the upper part 11 of the seat base 10 with seat assembly 40 in which these are displaced translationally as far back as possible and in the seating direction. The seat belt strap 36 is already fully tensioned due to the translational displacement and does not allow the upper section 11 to rotate to the right in the seating direction.

FIG. 2c shows an orientation of the upper part 11 of the seat base 10 with seat assembly 40, in which these are displaced translationally backward and in the seating direction but have not yet reached the maximum end position. In this position, the rotational movement of the upper part 11 of the seat base 10 with seat assembly 40 in the seating direction to the right is limited by the tensioning of the seat belt strap 36. As the upper section 11 is turned farther to the right, the seat belt strap 36 becomes increasingly taut until the seat belt strap 36 is fully tensioned and the maximum possible angle of rotation is reached. This means that unhindered rotation to the right is no longer possible. In the orientation in which the maximum angle of rotation of the upper part 11 is reached, no further translational movement of the upper part 11 to the rear is possible, as this movement is also limited by the seat belt strap 36.

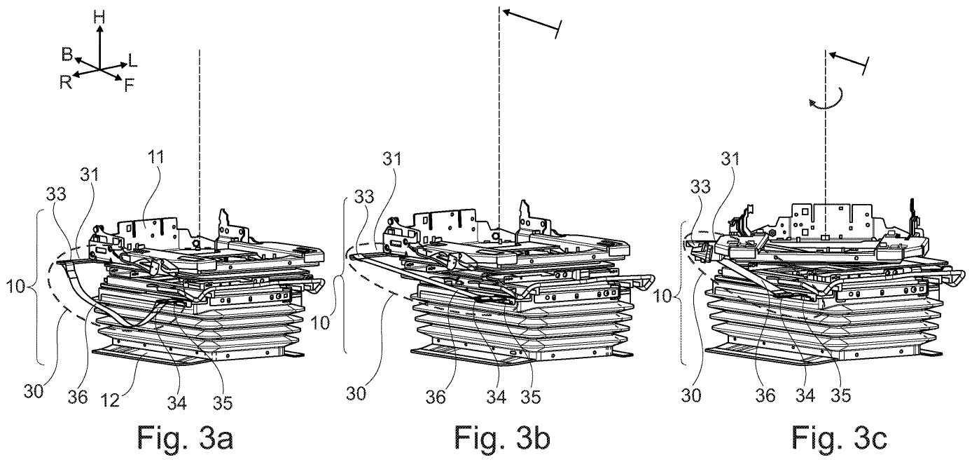

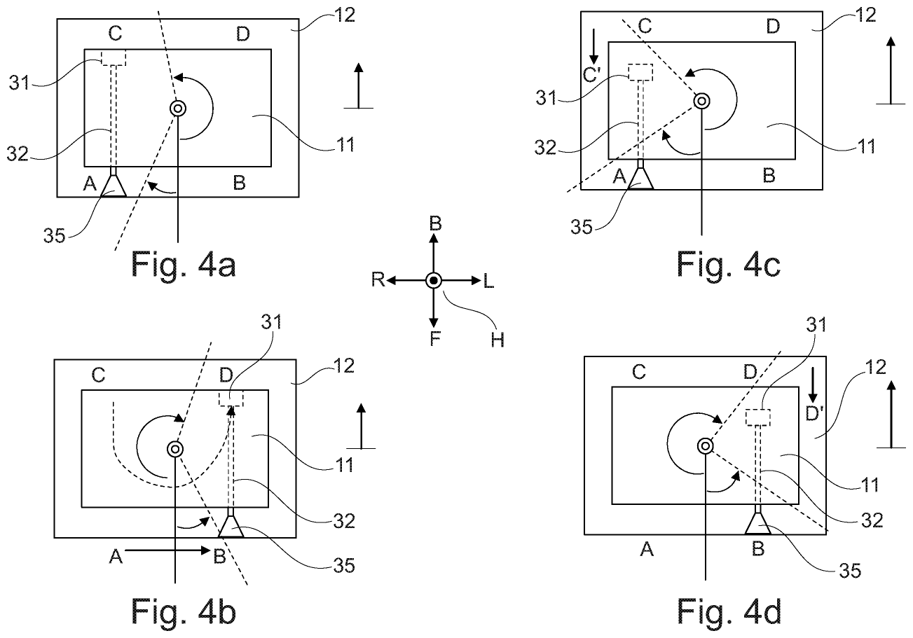

A retrofittable installation of an embodiment of a device for limiting a rotational and/or translational movement with connecting elements and a seat belt strap will be described with reference to FIGS. 3a to 3c. This is based on the embodiments shown above; in particular, the same reference symbols are used for elements with the same function as in FIGS. 1a to 1c. Differences from the embodiments already described are highlighted.

FIG. 3a shows an example of a device for limiting a rotational and/or translational movement 30 in a retrofittable installation position in a seat base 10. From left to right, different positions of the upper part 11 relative to the lower part 12 of the seat base 10 are shown in FIGS. 3a to 3c, resulting in different relative positions of the connecting elements 31 and 35 to one another. In one embodiment, the flexible limiting element is shown as a seat belt strap 36.

The rotational and/or translational movement that has led to the position shown is illustrated by the arrows above the figures. The coordinate system shows the orientation in the seating direction. The R-and L-axes indicate left and right; the direction B indicates the direction backward; and the direction F points forward. The H-axis is the vertical axis, which is also the axis of rotation. It is also shown by the dotted vertical line as the vertical axis of the upper part 11 of the seat base 10.

The construction remains the same for all positions shown. The construction corresponds to that in FIG. 2a, with the difference that the device for limiting a rotational and/or translational movement 30 is not integrated into the seat base 10 but is attached to the outside of the seat base 10. In addition, the seat assembly is not shown in FIGS. 3a to 3c.

The lower connecting element 35 is positioned at the front in the seating direction and on the right-hand side of the lower part 12 of the seat base 10. The upper connecting element 31 is positioned at the rear and on the right-hand side below the upper part 11 of the seat base 10.

The upper connecting element 31 is embodied as an L-shaped plate made of metal which has a circular recess for connecting the upper end 33 of the seat belt strap 36 and two through holes for fastening the upper connecting element 31 to the upper part 11 of the seat base 10. In the embodiment shown, the lower connecting element 35 is embodied as an angular element made of metal, which in turn has a circular recess to which the lower end 34 of the seat belt strap 36 is connected by means of a loop. The lower connecting element 35 also has two through holes at the angled end. The lower connecting element 35 is connected to the lower part 12 of the seat base.

The positions of the upper part of the seat base shown in FIGS. 3a to 3c correspond to the positions in FIG. 2 a to c, so that reference is made to these figures with regard to the description of the movement patterns.

The embodiment of the device for limiting a translational and rotational movement that is shown in FIGS. 3a to 3c allows the device to be attached from the outside. This makes it especially simple to retrofit the device without having to completely or partially remove and/or dismantle the seat. Nevertheless, the selected shape and attachment of the connecting elements 31 and 35 ensures that the seat belt strap 36 can be aligned freely. At the same time, the flat design of the connecting elements 31 and 35 requires little installation space, so that they can be retrofitted universally and for a large number of different seats.

A schematic representation of exemplary positions of the upper and lower connection points will be described with reference to FIGS. 4a to 4d. This is based on the embodiments shown above; in particular, the same reference symbols are used for elements with the same function as in FIGS. 1a to 1c. Differences from the embodiments already described are highlighted.

FIGS. 4 a to 4 d show a schematic representation of various positions A to D, C′, and D′ of the upper and lower connection points. A top view is shown of the installation of the device in a seat base with an upper part 11 and a lower part 12. Also shown schematically is a device for limiting a rotational and/or translational movement with a flexible limiting element 32, as well as an upper 31 and a lower connecting element 35. The position of the upper 31 and lower connecting element 35 also indicates the position of the upper and lower connection points.

The coordinate system shows the orientation in the seating direction. The R-and L-axes indicate left and right; the direction B indicates the direction backward; and the direction F points forward. The H-axis is the vertical axis, which is also the axis of rotation. The clockwise arrows show the possible rotation of the upper part 11 of the seat base about its vertical axis to the right in the seating direction, and the counterclockwise arrows show the possible rotation of the upper part 11 of the seat base about its vertical axis to the left in the seating direction. The vertical solid line, which starts from the center of the upper part 11, indicates the initial position. The dotted lines indicate the maximum permitted position after rotation to the left or right.

The construction of FIGS. 4a to 4d can be described with reference to FIG. 4a. The upper connection element 31 is fixed at the upper connection point below the upper part 11 of the seat base and is shown as a rectangle. The lower connecting element 35 is fixed to the lower connecting point on the lower part 12 of the seat base, shown as a triangle. The basic movement of the upper part 11 of the seat base relative to the lower part 12 of the seat base corresponds to the movement described for FIG. 1a and is the same for all shown FIGS. 4a to 4d. In contrast to the description of the movement in FIG. 1a, FIGS. 4a to 4d are intended to illustrate how a change in the position of the connecting elements 31 and 35 affects the maximum permitted movement of the upper part 11. The maximum rotation and maximum translation shown are displayed independently of one another for illustrative purposes only; in the application, these two movements are superposed.

FIG. 4a shows an initial position in which the upper connection point is at position C and the lower connection point is at position A. This corresponds to the positions described in FIG. 2a. The device for limiting a rotational and/or translational movement restricts the rotation of the upper part 11 of the seat base to the right more than the rotation to the left. If there is no rotation, the translation of the upper part 11 is limited to the extent shown by the arrow on the right of FIG. 4a.

FIG. 4b shows a change in the positions of the upper and lower connecting elements 31 and 35 from C to D and from A to B. The dashed arrow shows an example of the distance that the upper connecting element 31 would have to travel in order to adjust position C to a position D during use. The arrow shown from A to B is an example of the way in which the lower connecting element 35 can be adjusted from a position A to a position B. As a result, the device for limiting a rotational and/or translational movement is moved to the opposite side of the seat base, and the limitation of the rotation of the upper part of the seat base is limited more in the seating direction to the left than in the seating direction to the right. The limitation of the translational movement is not changed.

FIG. 4c shows, in comparison to FIG. 4a, a change in the position of the upper connecting element 31 from C to C′. This shortens the distance between the connection points, which results in greater freedom of movement for the rotational movement of the upper part 11 of the seat base in both directions. If there is no rotation, the translation of the upper part 11 is limited to the extent shown by the arrow on the right of FIG. 4c. Compared to the positioning in FIG. 4a, more translational movement is therefore permitted.

FIG. 4d shows, in comparison to FIG. 4b, a change in the position of the upper connecting element 31 from D to D′. This shortens the distance between the connection points, which results in greater freedom of movement for the rotational movement of the upper part 11 of the seat base in both directions. If there is no rotation, the translation of the upper part 11 is limited to the extent shown by the arrow on the right of FIG. 4d. Compared to the positioning in FIG. 4b, more translational movement is therefore permitted.

The different positions of the connecting elements 31 and 35 in FIGS. 4a to 4d show what effect the positioning has on limiting the translation and rotation of the upper part 11 of the seat base. A change in the positions of the connecting elements 31 and 35 from the right-hand side of the vertical axis in the seating direction to the left-hand side is accompanied by a reversal of the direction of greater and lesser limitation of a rotational movement of the upper part 11 of the seat base. This does not change the limitation of the translational movement. Changing the positions in such a way that the distance between the connecting elements 31 and 35 is reduced while the length of the flexible limiting element 32 remains the same is accompanied by an increase in the rotational and translational range of movement. In the exemplary embodiment shown, the positions can also be adjusted by the user during use, which allows for additional customization.

With the device according to the invention for limiting a rotational and/or translational movement, the seat for a vehicle which has a device for limiting a rotational and/or translational movement, and the use of a flexible limiting element for limiting a rotational and/or translational movement, it is possible to solve the known problems which arise when, on the one hand, a vehicle seat is to be rotatable and, on the other hand, the space available in a vehicle is limited. According to the invention, the device couples a permissible translational and/or rotational movement, in particular by means of at least one flexible limiting element. This means that a maximum permissible angle of rotation or a maximum translational path that can be performed can be determined automatically as a function of the previous translational displacement of a seat and/or the rotation thereof.

### LIST OF REFERENCE SYMBOLS

1 seat
10 seat base
11 upper part of the seat base
12 lower part of the seat base
16 upper connection point
17 lower connection point
20 adjusting unit
21 rotation element
22 translation element
30 rotational and translational movement-limiting device
31 upper connecting element
32 flexible limiting element
33 upper end of the flexible limiting element
34 lower end of the flexible limiting element
35 lower connecting element
36 seat belt strap
37 automatic retractor
40 seat assembly

1. A device for limiting a rotational and translational movement for a seat base (10), the seat base comprising an upper part and a lower part, the upper part and the lower part being rotationally and/or translationally movable relative to one another by means of an adjusting unit; comprising
at least one flexible limiting element with an upper end and with a lower end;
wherein the upper end is fixed at an upper connection point on the upper part;
wherein the lower end is fixed at a lower connection point on the lower part;
wherein the at least one flexible limiting element limits the translational and/or rotational movement of the upper part and of the lower part relative to one another.

2. The device according to claim 1, wherein the limitation of the translational and/or rotational movement is adjustable via a relative position of the upper connection point and of the lower connection point to one another and/or via a length of the flexible limiting element.

3. The device according to claim 1, wherein the flexible limiting element is a belt, in particular a seat belt strap.

4. The device according to claim 1, wherein the flexible limiting element can be rolled up, in particular by means of an automatic retractor.

5. The device according to claim 1, wherein the position of the upper connection point and/or the position of the lower connection point is adjustable.

6. A seat for a vehicle, in particular for a utility vehicle, comprising a device for limiting a rotational and translational movement according to claim 1.

7. Use of at least one flexible limiting element for limiting a rotational and/or translational movement of an upper part and of a lower part relative to one another, wherein the movement is limited by fixing an upper end of the flexible limiting element to an upper connection point on the upper part and a lower end of the flexible limiting element to a lower connection point on the lower part.
